(19) United States
(12) Patent Application Publication
(10) Pub. No.: US 2019/0224911 A1
(43) Pub. Date: Jul. 25, 2019

(54) SUB-RESOLUTION FEATURES IN ADDITIVE MANUFACTURED COMPONENTS

(71) Applicants: Rolls-Royce Corporation, Indianapolis, IN (US); Rolls-Royce North American Technologies, Inc., Indianapolis, IN (US)

(72) Inventors: Quinlan Yee Shuck, Indianapolis, IN (US); Scott Nelson, Carmel, IN (US); Brandon David Ribic, Noblesville, IN (US); Matthew R. Gold, Carmel, IN (US)

(21) Appl. No.: 16/254,978

(22) Filed: Jan. 23, 2019

Related U.S. Application Data
(60) Provisional application No. 62/620,795, filed on Jan. 23, 2018.

(51) Int. Cl. B29C 64/135; B29C 64/118; B29C 64/393; B33Y 10/00; B33Y 30/00; B33Y 50/02

(52) U.S. Cl. CPC B29C 64/135; B29C 64/118; B29C 64/393; B29K 2105/0002; B33Y 30/00; B33Y 50/02; B33Y 10/00

(57) ABSTRACT

An additive manufacturing technique may include forming, on a structured surface of a substrate, a layer of material using an additive manufacturing technique. The structured surface of the substrate includes at least one feature having a smallest dimension or a smallest radius of curvature smaller than a base resolution of the additive manufacturing technique. The layer of material substantially reproduces a complementary shape that is complementary to the at least one feature. The method may further include forming, on the layer of material, at least one additional layer of material to form an additively manufactured component including the complementary shape.

This application claims the benefit of U.S. Provisional Patent Application No. 62/620,795, filed Jan. 23, 2018, the entire contents of which are incorporated herein by reference.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing volume to generate the three-dimensional structure. Additive manufacturing may be advantageous in many situations, such as rapid prototyping, forming components with complex three-dimensional structures, or the like. In some examples, additive manufacturing may include fused deposition modeling, in which heated material, such as polymer, is extruded from a nozzle and cools to be added to the structure, or stereolithography, in which an energy source is used to selectively cure a liquid photopolymer resin to a desired shape of the component.

### SUMMARY

In some examples, the disclosure describes an additive manufacturing system that includes a substrate comprising a structured surface including at least one feature having a smallest dimension or a smallest radius of curvature smaller than a base resolution of the additive manufacturing system. The additive manufacturing system also may include means for additively forming layers of material using an additive manufacturing technique and a computing device. The computing device is configured to control the means for additively forming layers to form a layer of material on the structured surface of the substrate. The layer of material substantially reproduces a complementary shape to the at least one feature. The computing device is also configured to control the means for additively forming layers to form, on the layer of material, at least one additional layer of material to form an additively manufactured component that includes the complementary shape.

In some examples, the disclosure describes a method that includes forming, on a structured surface of a substrate, a layer of material using an additive manufacturing technique. The structured surface of the substrate includes at least one feature having a smallest dimension or a smallest radius of curvature smaller than a base resolution of the additive manufacturing technique. The layer of material substantially reproduces a complementary shape to the at least one feature. The method may further include forming, on the layer of material, at least one additional layer of material to form an additively manufactured component that includes the complementary shape.

In some examples, the disclosure describes a computer-readable storage device including instructions that, when executed, configure one or more processors of a computing device to control means for additively forming layers of material using an additive manufacturing technique to form, on a structured surface of a substrate, a layer of material using an additive manufacturing technique. The structured surface of the substrate includes at least one feature having a smallest dimension or a smallest radius of curvature smaller than a base resolution of the additive manufacturing technique. The layer of material substantially reproduces a complementary shape to the at least one feature. The computer-readable storage device also includes instructions that, when executed, configure the one or more processors of the computing device to control the means for additively forming layers of material to form, on the layer of material, at least one additional layer of material to form an additively manufactured component that includes the complementary shape.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating an example system for performing an additive manufacturing technique to form additively manufactured components including at least one feature having a minimum size or a minimum radius of curvature that is less than a base resolution of the additive manufacturing technique.

FIG. 2 is a conceptual block diagram illustrating another example system for performing an additive manufacturing technique to form additively manufactured components including at least one feature having a minimum size or a minimum radius of curvature that is less than a base resolution of the additive manufacturing technique.

FIGS. 3A and 3B are conceptual diagrams illustrating example surface features in a substrate, where the surface features have a size or radius of curvature smaller than a base resolution of the additive manufacturing technique.

FIG. 3C is a conceptual diagram illustrating example features in an additively manufactured component, where the features have a size or radius of curvature smaller than a base resolution of the additive manufacturing technique.

FIGS. 4A-4H are conceptual diagrams illustrating example features formed in a structured surface of a substrate, where the surface features have a size or radius of curvature smaller than a base resolution of the additive manufacturing technique.

FIG. 5 is a flow diagram illustrating an example technique for forming an additively manufactured component including at least one feature smaller than a base resolution of the additive manufacturing technique.

FIG. 6 is a flow diagram illustrating an example technique for forming an additively manufactured component including at least one feature smaller than a base resolution of the additive manufacturing technique.

### DETAILED DESCRIPTION

The disclosure generally describes techniques for forming additively manufactured components including at least one feature having a minimum size or a minimum radius of curvature that is less than a base resolution of the additive manufacturing technique used to form the components (in the absence of the structured substrate described herein). The technique uses a substrate that includes a structured surface including at least one surface feature having a smallest dimension or a smallest radius of curvature smaller than a base resolution of the additive manufacturing technique. Means for additively forming layers of material using an additive manufacturing technique may be used to form a layer of material on the structured surface of the substrate, including on the at least one surface feature. The layer of material may substantially reproduce a complementary shape to the at least one surface feature. In this way, the technique may enable production of additively manufactured components with features having dimensions or radii of curvature smaller than a base resolution of the additive manufacturing technique. The complementary shape may be on a surface of the additively manufactured component, or may be incorporated within the additively manufactured component following subsequent steps of the additively manufacturing technique. In some examples, the additive manufacturing technique may be fused deposition modeling or stereolithography.

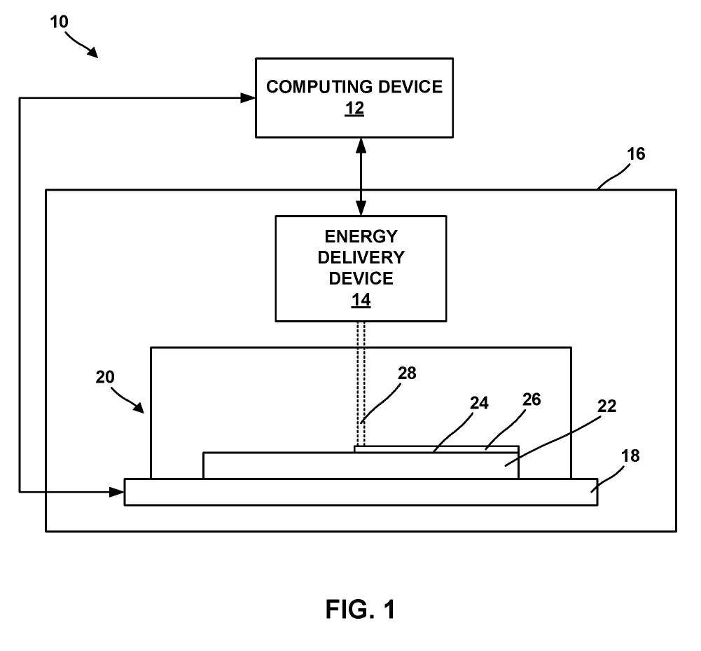

FIG. 1 is a conceptual block diagram illustrating an example additive manufacturing system 10 for performing an additive manufacturing technique to form additively manufactured components including at least one feature having a minimum size or a minimum radius of curvature that is less than a base resolution of the additive manufacturing technique. In the example illustrated in FIG. 1, system 10 includes a computing device 12, an energy delivery device 14, an enclosure 16, a stage 18, a vat 20, and a substrate 22. Computing device 12 is operably connected to energy delivery device 14 and stage 18. In the example of FIG. 1, additive manufacturing system 10 is a stereolithographic printing system.

In some examples, additive manufacturing system 10 includes enclosure 16, which at least partially encloses energy delivery device 14, stage 18, vat 20, and substrate 22. Enclosure 16 may provide physical protection to energy delivery device 14, stage 18, vat 20, and substrate 22 during operation of additive manufacturing system 10, may maintain an atmosphere within enclosure 16 in a desired state (e.g., filled with a gas that is substantially inert to a liquid photopolymer resin in vat 20 or maintained at a desired temperature), or the like.

In some examples, stage 18 is movable relative to energy delivery device 14 and/or energy delivery device 14 is movable relative to stage 18. For example, stage 18 may be translatable and/or rotatable along at least one axis to position substrate 22 relative to energy delivery device 14. Similarly, energy delivery device 14 may be translatable and/or rotatable along at least one axis to position energy delivery device 14 relative to substrate 22. Stage 18 may be configured to selectively position and restrain substrate 22 in place relative to stage 18 during manufacturing of the additively manufactured component.

Vat 20 may be positioned on stage 18 and may contain a liquid photopolymer resin. The photopolymer may include oligomers, such as epoxides, urethanes, polyethers, polyesters, or mixtures thereof. In some examples, the oligomers may be functionalized by a reactive group, such as an acrylate. The liquid photopolymer resin also may include monomers that may affect cure rates, crosslink density of the cured resin, viscosity of the liquid photopolymer resin, or the like. Example monomers may include styrene, N-vinylpyrrolidone, acrylates, or the like. The liquid photopolymer resin further may include a photoinitiator.

In some examples, as shown in FIG. 1, additive manufacturing system 10 may cure the liquid photopolymer resin in a top-down orientation. In other examples, additive manufacturing system 10 may cure the liquid photopolymer resin in a bottom-up orientation, in which case the orientation of stage 18, vat 20, and energy delivery device 14 may be vertically flipped (i.e., energy delivery device 14 may be below and focused up toward stage 18).

Energy delivery device 14 may include an energy source, such as a laser source, an electron beam source, plasma source, or another source of energy that may be absorbed by the liquid photopolymer resin. Example laser sources include a CO laser, a CO₂ laser, a Nd:YAG laser, or the like. In some examples, the energy source may be selected to provide energy with a predetermined wavelength or wavelength spectrum that may be absorbed by the liquid photopolymer resin, e.g., a wavelength or wavelength range in the ultraviolet wavelength spectrum.

In some examples, energy delivery device 14 also includes an energy delivery head, which is operatively connected to the energy source. The energy delivery head may focus or direct the energy toward predetermined positions adjacent substrate 22 or within vat 20 during the additive manufacturing technique. As described above, in some examples, the energy delivery head may be movable in at least one dimension (e.g., translatable and/or rotatable) under control of computing device 12 to direct the energy toward a selected location adjacent substrate 22 or within vat 20.

Computing device 12 may include, for example, a desktop computer, a laptop computer, a workstation, a server, a mainframe, a cloud computing system, or the like. Computing device 12 is configured to control operation of additive manufacturing system 10, including, for example, energy delivery device 14, stage 18, or both. Computing device 12 may be communicatively coupled to energy delivery device 14, stage 18, or both using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like.

Computing device 12 may be configured to control operation of energy delivery device 14, stage 18, or both to position substrate 22 relative to energy delivery device 14. For example, as described above, computing device 12 may control stage 18 and energy delivery device 14 to translate and/or rotate along at least one axis to position substrate 22 relative to energy delivery device 14. Positioning substrate 22 relative to energy delivery device 14 may include positioning a structured surface (e.g., a surface to which material is to be added) of substrate 22 in a predetermined orientation relative to energy delivery device 14.

For example, during manufacturing of an additively manufactured component with additive manufacturing system 10, computing device 12 may control movement of energy delivery device 14, stage 18, or both, based on a computer aided manufacturing or computer aided design (CAM/CAD) file. Computing device 12 may control movement of energy delivery device 14 to cause energy beam 28 to trace a desired shape or design in a layer of the liquid photopolymer resin, e.g., a layer of the liquid photopolymer resin adjacent to structured surface 24 of substrate 22, curing the liquid photopolymer resin at locations substantially corresponding to the traced shape or design, e.g., in a layer 26. Computing device 12 then may control stage 18 to move, e.g., away from energy delivery device 14, which may result in uncured liquid photopolymer resin covering the traced shape or design. Computing device 12 may again control movement of energy delivery device 14 to cause energy beam 28 to trace a second desired shape or design in the uncured liquid photopolymer resin on the cured photopolymer, curing the liquid photopolymer resin at locations substantially corresponding to the second traced shape or design. Computing device 12 may control stage 18 and energy delivery device 14 in this manner to result in a plurality of cured photopolymer layers, each layer including a traced shape or design. Together, the plurality of cured photopolymer layers defines an additively manufactured component.

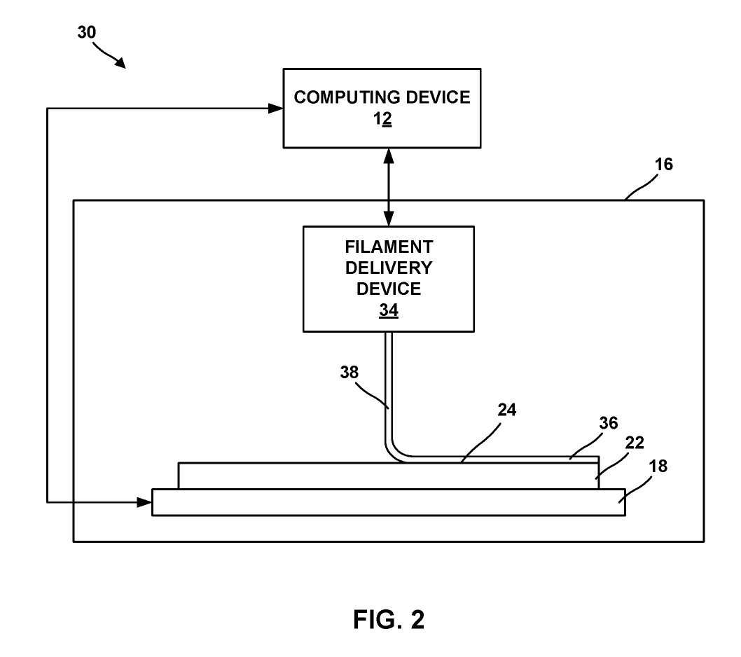

FIG. 1 illustrates a first means for additively forming layers of material using an additive manufacturing technique. FIG. 2 illustrates a second example means for additively forming layers of material using an additive manufacturing technique. FIG. 2 is a conceptual block diagram illustrating another example additive manufacturing system 30 for performing an additive manufacturing technique to form additively manufactured components including features having a minimum size or a minimum radius of curvature that is less than a base resolution of the additive manufacturing technique. Additive manufacturing system 30 is a fused deposition modelling or fused filament fabrication system.

Like additive manufacturing system 10 of FIG. 1, additive manufacturing system 30 may include computing device 12, enclosure 16, and stage 18. Each of these components may be similar to or substantially the same as the respective components in FIG. 1.

Instead of energy delivery device 14, additive manufacturing system 30 includes filament delivery device 34. Filament delivery device 34 may include a filament reel that holds wound filament. The filament may include a polymeric material, such as a thermoplastic. Example thermoplastics include polyolefins, polystyrene, acrylonitrile butadiene styrene, polylactic acid, thermoplastic polyurethanes, aliphatic polyamides, or the like.

Filament delivery device 34 may advance the filament from the reel and heat the filament to above a softening or melting point of the filament. The softened or melted material 38 is then extruded from a nozzle and laid down in a road 36 on structured surface 24 of substrate 22 (or in subsequent layers, on a previously deposited road). The softened or melted material 38 cools and, in this way, is joined to other roads.

Similar to energy delivery device 14, computing device 12 may control movement and positioning of filament delivery device 34 relative to stage 18, and vice versa, to control the locations at which roads 36 are formed. Computing device 12 may control movement of energy delivery device 14, stage 18, or both, based on a computer aided manufacturing or computer aided design (CAM/CAD) file. For example, computing device 12 may control filament delivery device 34 to trace a pattern or shape to form a layer including a plurality of roads on structured surface 24. Computing device 12 may control filament delivery device 34 or stage 18 to move substrate 22 away from filament delivery device 34, then control filament delivery device 34 to trace a second pattern or shape to form a second layer including a plurality of roads on the first layer. Computing device 12 may control stage 18 and filament delivery device 34 in this manner to result in a plurality of layers, each layer including a traced shape or design. Together, the plurality of layers defines an additively manufactured component.

Fused filament modelling and stereolithography each have base resolutions. As used herein, base resolution refers to a minimum size controllably producible by the additive manufacturing technique. The base resolution of fused filament modelling may be related to a diameter of the filament, a diameter of the nozzle of the filament delivery device 34, or both. Further, the base resolution may be reduced at locations where a direction of travel of filament delivery device 34 changes, as softened or molten material 38 may lack mechanical properties to precisely reproduce the change of direction of filament delivery device 34. Further, for fused filament modelling, cooling of the roads may induce dimensional changes and shape distortion, reducing a base resolution of the fused filament modelling.

The base resolution of stereolithography may be related to a focal size of energy beam 28. Similar to fused filament modelling, temperature changes during the curing process may induce dimensional changes and shape distortion during stereolithography, reducing a base resolution of the stereolithography technique.

Fused filament modelling and stereolithography also may have accuracy limits, where accuracy refers to the shape of the additively manufactured component produced by the additive manufacturing technique compared to an intended shape of the additively manufactured component. This also may introduce unwanted surface roughness to the additively manufactured component. For example, during fused filament modelling, filament delivery device 34 may drag softened or molten material 38 during changes in direction used to define edges or surfaces of shapes. Similarly, during stereolithography, a focal size of energy beam 28 may affect the accuracy of the technique and introduce unwanted surface roughness to the additively manufactured component. Shape distortion and dimensional changes due to temperature changes may also reduce accuracy of fused filament modelling and stereolithography.

In accordance with examples of this disclosure, substrate 22 may include a structured surface 24 that includes at least one surface feature having a smallest dimension or a smallest radius of curvature that is smaller than a base resolution of additive manufacturing system 10 or additive manufacturing system 30, e.g., small than a base resolution of energy delivery device 14 or filament delivery device 34 or a base positioning resolution of stage 18 relative to energy delivery device 14 or filament delivery device 34. For example, some fused filament deposition manufacturing systems may have a base resolution of about 1.75 mm, which is the diameter of a filament. Other fused filament deposition manufacturing systems may have a base resolution of greater than about 300 micrometers, which is a diameter of a nozzle. Some stereolithographic manufacturing systems may have a base resolution of about 250 micrometers, which is a diameter of a focal point of energy beam 28. Thus, in some examples, a smallest dimension or a smallest radius of curvature of the at least one surface feature may be less than about 1.75 mm, less than about 500 micrometers, less than about 300 micrometers, or less than about 250 micrometers.

Substrate 22 may be formed from any suitable material with dimensional accuracy and stability sufficient to reproduce structured surface 24 and the surface features defined therein. Substrate 22 and structured surface 24 including the surface features may be formed by any appropriate manufacturing technique, including, for example, molding, casting, machining (e.g., milling, grinding, etching, or the like), additive manufacturing in a metal or alloy and post-processing to smooth the surface, or the like.

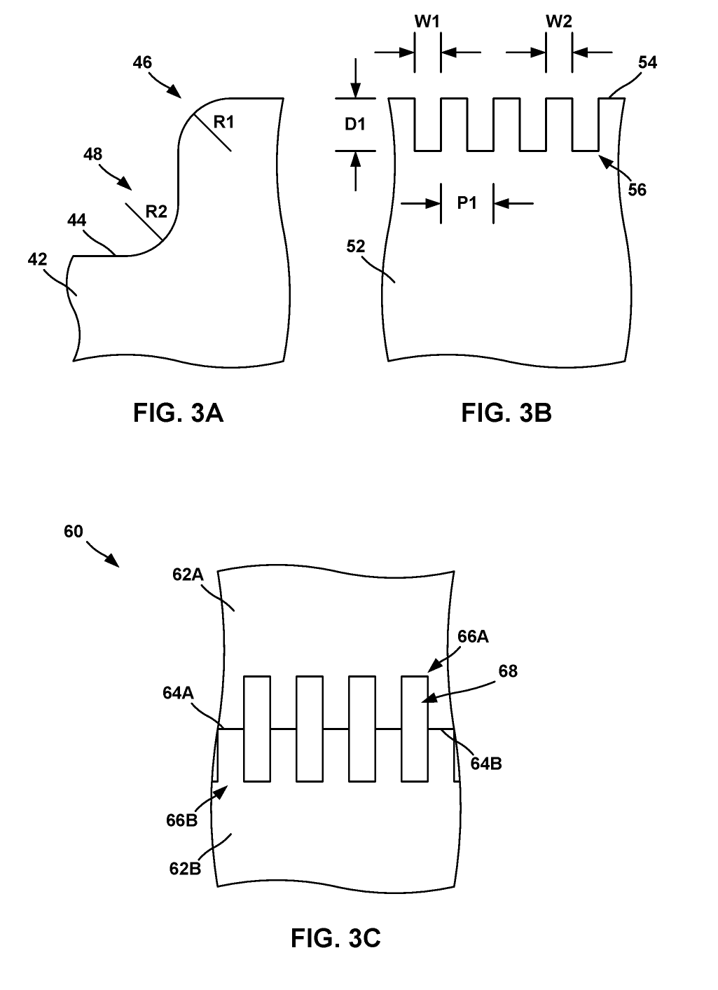

FIGS. 3A and 3B are conceptual diagrams illustrating example surface features in a substrate, where the surface features have a size or radius of curvature smaller than a base resolution of the additive manufacturing technique. For example, FIG. 3A illustrates a substrate 42 defining a structured surface 44. Structured surface includes a first feature 46 and a second feature 48. First feature 46 has a radius of curvature R1, and second feature 48 has a radius of curvature R2. R1, R2, or both may be smaller than a base resolution of the additive manufacturing technique used with substrate 42 to form an additively manufactured component. For example, R1, R2, or both may be less than about 1.75 mm, less than about 500 micrometers, less than about 300 micrometers, or less than about 250 micrometers, depending on the base resolution of the additive manufacturing technique. R1 and R2 may be the same, or may be different. The additively manufactured component formed using substrate 42 may include a complementary shape to surface features 46 and 48 and, thus, may include features with radii of curvature smaller than a base resolution of the additive manufacturing technique.

FIG. 3B illustrates a substrate 52 including a structured surface 54 that includes a plurality of channels 56. Each of channels 56 defines a smallest dimension that is smaller than a base resolution of the additive manufacturing technique with which substrate 52 is used. For example, each channel of channels 56 defines a width W1, and the space between adjacent channels defines a pillar having a width W2. Each channel of channels 56 also defines a depth D1. Further, the plurality of channels 56 may be spaced with a pitch P1 between similar locations of adjacent channels. One or more of width W1, width W2, depth D1, or pitch P1 may be smaller than a base resolution of the additive manufacturing technique with which substrate 52 is used. In some examples, two or more dimensions (e.g., width W1 and depth D1) may be smaller than a base resolution of the additive manufacturing technique.

In some examples, rather than including a plurality of channels 56, substrate 52 may include a single channel. In other examples, rather than the plurality of channels 56 being substantially parallel to each other, plurality of channels 56 may be non-parallel, e.g., diverging, intersecting, or the like. For example, plurality of channels 56 may define a grid pattern in which respective channels of plurality of channels 56 intersect each other and define plateaus in structured surface 54. Alternatively, rather than being continuous channels 56, discrete depressions may be formed in structured surface 54.

In some examples, plurality of channels 56 may be substantially straight, while in other examples, plurality of channels 56 may define other shapes, such curved, curvilinear, sinusoidal, or the like. Plurality of channels 56 may define any cross-sectional shape, including rectangular (as shown in FIG. 3B), triangular, trapezoidal, curvilinear, or the like.

The additively manufactured component formed using substrate 52 may include a complementary shape to structured surface 54 and, thus, may include channels, pillars, plateaus, or other protrusions with a smallest dimension that is smaller than a base resolution of the additive manufacturing technique.

Structured surfaces 44 and 54 may facilitate accurate reproduction of features 46 and 48 and channels 56, e.g., compared to defining features 46 and 48 or channels 56 using only rastering of energy delivery device 14 or filament delivery device 34. This may result in greater geometric accuracy, higher resolution, or both in an additively manufactured component formed using substrates 42 or 52. For example, in a stereolithographic printing system, the liquid photopolymer resin may flow into intimate contact with structured surface 44 or 54 such that the liquid photopolymer resin accurately reproduces the shape of features 46 and 48 or channels 56, respectively. Computing device 12 may cause energy delivery device 14 to trace a focal point of energy beam 28 along or around features 46 and 48 or channels 56. In some examples, computing device 12 may cause energy delivery device 14 to trace the focal point of energy beam 28 such that the focal point partially overlaps structured surface 44 or 54, such that the liquid photopolymer resin is cured at the structured surface 44 or 54 to substantially reproduce (e.g., reproduce or nearly reproduce) a complementary shape to structured surface 44 or 54 features 46 and 48 or channels 56.

Similarly, in a fused filament deposition technique, softened or melted material 38 may be sufficiently soft or non-viscous to flow into intimate contact with the features 46 and 48 or channels 56. Softened or melted material 38 may then cool and harden to substantially reproduce (e.g., reproduce or nearly reproduce) a complementary shape to structured surface 44 or 54, including features 46 and 48 or channels 56. In this way, structured surface 44 or 54 may enable greater geometric accuracy, higher resolution, smoother surfaces, or combinations thereof in the additively manufactured component formed using substrate 42 or 52.

In some examples, substrate 22 including structured surface 24 may be used to form features internal to an additively manufactured component. FIG. 3C is a conceptual diagram illustrating example features in an additively manufactured component 60, where the features have a size or radius of curvature smaller than a base resolution of the additive manufacturing technique. FIG. 3C illustrates a first additively manufactured component 62A including a first surface 64A that includes a first plurality of complementary features 66A and a second additively manufactured component 62B including a second surface 64B that includes a second plurality of complementary features 66B. First additively manufactured component 62A is joined to second additively manufactured component 62B such that the first plurality of complementary features 66A and second plurality of complementary features 66B together define channels or cavities 68. For example, first additively manufactured component 62A may be formed using additive manufacturing and a substrate like substrate 52 of FIG. 3B. Similarly, first additively manufactured component 62A may be formed using additive manufacturing and a substrate like substrate 52 of FIG. 3B. The substrate used to form first additively manufactured component 62A may be the same or different from the substrate used to form second additively manufactured component 62B. After separately forming first additively manufactured component 62A and second additively manufactured component 62B, first and second surfaces 64A and 64B may be joined, e.g., using an adhesive, solvent casting, or the like.

The surface features may be used to define shapes of functional features in the additively manufactured components. For example, the additively manufactured component may be a component used in a high temperature environment, such as a gas turbine engine, and the functional features in the additively manufactured component may be cooling channels or other features used for thermal management for the additively manufactured component. By enabling formation of relatively closely spaced features, the structured surfaces described herein may allow formation of effective and efficient thermal management structures.

As another example, the additively manufactured component may be a component used in an application where aerodynamic performance is a consideration. Enabling higher accuracy and smaller features may improve aerodynamic performance of the additively manufactured component compared to additively manufactured components formed without using the structured surfaces described herein.

The additively manufactured component alternatively may be a component joined to another component, such that the shape of the surface of the additively manufactured component should be accurate and precise to improve adhesion, retention, or mechanical joining of the additively manufactured component to the other component. By improving accuracy and resolution of the additive manufacturing technique, the structured surfaces described herein may improve adhesion, retention, or mechanical joining of the additively manufactured component to another component compared to additively manufactured components formed without using the structured surfaces described herein.

The additively manufactured component also may be used in applications such as chemical sensing or purification, such as chromatography or the like.

In some examples, structured surface 24 may include features configured to modify the surface of layer 26 to be more hydrophobic or more hydrophilic than base hydrophilicity or hydrophobicity of the material from which layer 26 is formed. For example, structured surface 24 may define a plurality of relatively narrow, elongated depressions, such that the complementary shapes formed in layer 26 include relatively narrow, elongated spikes, cones, or pyramidal shapes. The relatively narrow, elongated spikes, cones, or pyramidal shapes may be spaced from each other at a distance, and together may result in the surface of layer 26 being more hydrophobic than the base hydrophobicity of the material from which layer 26 is formed.

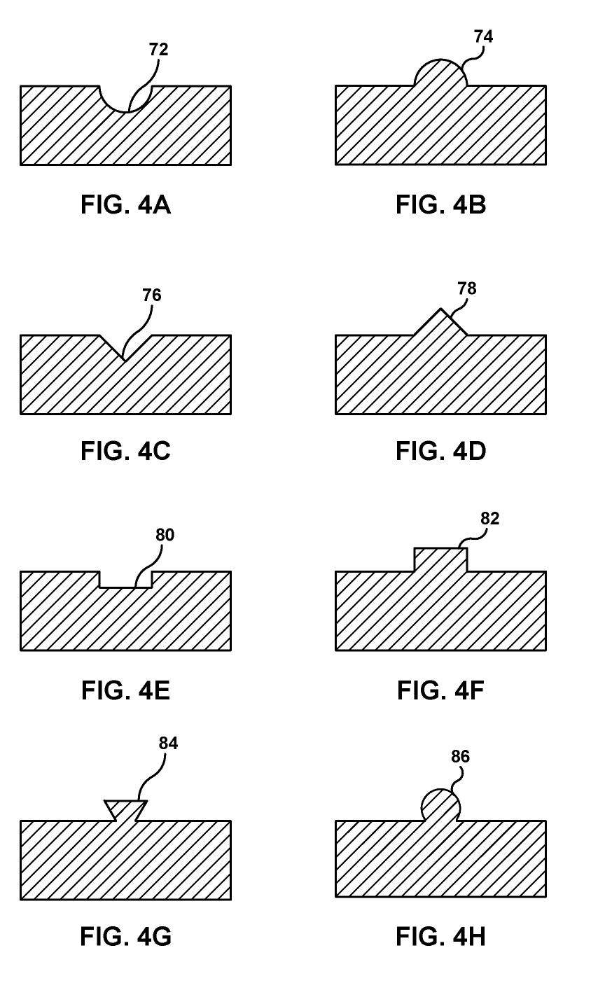

In some examples, structured surface 24 may include features that result in features in layer 26 that increase mechanical adhesion of a subsequent coating to the additively manufactured component. For example, FIGS. 4A-4H illustrate example surface features in a structured surface 24. The three-dimensional surface features may include, for example, continuous or discrete depressions or grooves, continuous or discrete protrusions or ridges, or combinations thereof. The three-dimensional surface features may include any suitable cross-sectional profile. FIGS. 4A and 4B illustrate a depression or groove 72 and a protrusion or ridge 74, respectively, including a generally curved cross-sectional profile (e.g., groove or ridge having a cross-section of a portion of a circle, or depression or protrusion having a shape of a portion of a sphere). FIGS. 4C and 7D illustrate a depression or groove 76 and a protrusion or ridge 78, respectively, including a triangular cross-sectional profile. For example, a depression 76 or protrusion 78 may comprise a conical shape or a pyramidal shape. FIGS. 4E and 4F illustrate a depression or groove 80 and a protrusion or ridge 82, respectively, having a generally rectangular cross-sectional profile.

FIGS. 4G and 4H illustrate protrusions or ridges 84 and 86, respectively, having undercut profile. In various examples, the undercut profile may include various shapes such as a trapezoid (shown in FIG. 4G) or arc (shown in FIG. 4H). Other shapes are contemplated such as a fir tree or keyed shape.

Features 72, 74, 76, 78, 80, 82, 84, or 86 (collectively “features 72”) may be formed in structured surface 24 in an array comprising a plurality of features 72. Features 72 may result in complementary shaped features being formed in layer 26 or road 36. The complementary shaped features may improve adhesion between layer 26 or road 36 and a subsequent coating, e.g., by forming mechanical interlocks or mechanical interference with the complementary shaped features. The coating may include, for example, a metal or alloy coating selected to provide desired properties to the surface of the additively manufactured part.

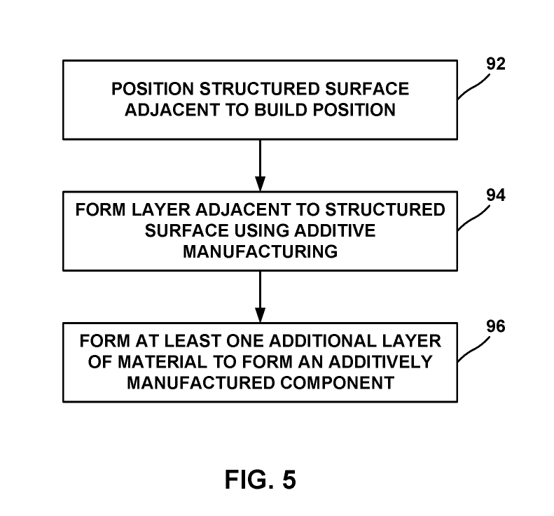

An example technique that may be implemented by system 10 or 30 will be described with concurrent reference to FIG. 5. FIG. 5 is a flow diagram illustrating an example technique for forming an additively manufactured component including at least one feature smaller than a base resolution of the additive manufacturing technique. Although the technique of FIG. 5 is described with respect to system 10 of FIG. 1, in other examples, the technique of FIG. 5 may be performed by other systems, such as system 30 of FIG. 2 or other systems including fewer or more components than those illustrated in FIG. 1. Similarly, systems 10 and 30 may be used to performed other additive manufacturing techniques (e.g., the technique illustrated in FIG. 5).

The technique of FIG. 5 includes positioning substrate 22 including structured surface 24 adjacent to a build position, e.g., on stage 18 (92). Structured surface 24 includes at least one surface feature having a smallest dimension or a smallest radius of curvature smaller than a base resolution of the additive manufacturing technique. The at least one surface feature may include any of the surface features described herein, including, for example, surface features 46 and 48 of FIG. 3A, channels 56 of FIG. 3B, or features 72, 74, 76, 78, 80, 82, 84, or 86 of FIGS. 4A-4H.

The technique of FIG. 5 also includes forming a layer 26 of material using an additive manufacturing technique (94). For example, in a stereolithographic printing system such as additive manufacturing system 10, the liquid photopolymer resin in vat 20 may flow into intimate contact with structured surface 24 such that the liquid photopolymer resin accurately reproduces the shape of the surface features of structured surface 24, respectively. Computing device 12 may cause energy delivery device 14 to trace a focal point of energy beam 28 along or around the surface features of structured surface 24 and any other predetermined pattern or shape desired for layer 26. In some examples, computing device 12 may cause energy delivery device 14 to trace the focal point of energy beam 28 such that the focal point partially overlaps structured surface 24, such that the liquid photopolymer resin is cured at the structured surface 24 to substantially reproduce (e.g., reproduce or nearly reproduce) a complementary shape to structured surface 24.

The technique of FIG. 5 also includes forming, on layer 26 of material, at least one additional layer of material to form an additively manufactured component including the complementary shape (96). For example, computing device 12 may control movement of energy delivery device 14, stage 18, or both, based on a computer aided manufacturing or computer aided design (CAM/CAD) file. Computing device 12 may control movement of energy delivery device 14 to cause energy beam 28 to trace a desired shape or design in a layer of the liquid photopolymer resin to form each additional layer of material, curing the liquid photopolymer resin at locations substantially corresponding to the traced shape or design. Computing device 12 then may control stage 18 to move, e.g., away from energy delivery device 14, which may result in uncured liquid photopolymer resin covering the traced shape or design. Computing device 12 may again control movement of energy delivery device 14 to cause energy beam 28 to trace a desired shape or design in the uncured liquid photopolymer resin on the cured photopolymer, curing the liquid photopolymer resin at locations substantially corresponding to the traced shape or design. Computing device 12 may control stage 18 and energy delivery device 14 in this manner to result in a plurality of cured photopolymer layers, each layer including a traced shape or design. Together, the plurality of cured photopolymer layers defines an additively manufactured component.

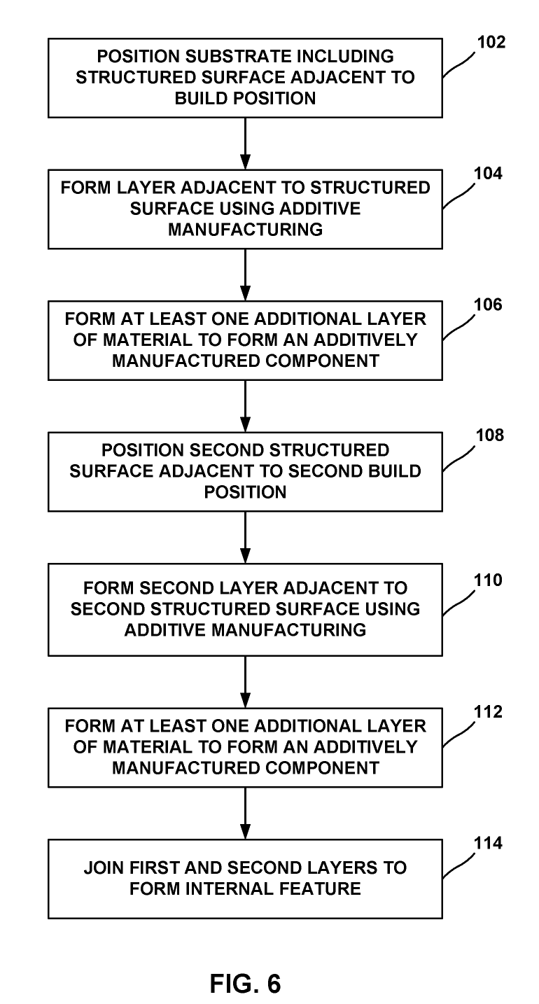

As described above, in some examples, the techniques described herein may be used to form features internal to an additively manufactured component. An example technique that may be implemented by system 10 or 30 will be described with concurrent reference to FIG. 6. FIG. 6 is a flow diagram illustrating an example technique for forming an additively manufactured component including at least one internal feature smaller than a base resolution of the additive manufacturing technique. Although the technique of FIG. 6 is described with respect to system 30 of FIG. 2, in other examples, the technique of FIG. 6 may be performed by other systems, such as system 10 of FIG. 1 or other systems including fewer or more components than those illustrated in FIG. 2. Similarly, systems 10 and 30 may be used to performed other additive manufacturing techniques (e.g., the technique illustrated in FIG. 5).

The technique of FIG. 6 includes positioning substrate 22 including structured surface 24 adjacent to a build position, e.g., on stage 18 (102). Structured surface 24 includes at least one surface feature having a smallest dimension or a smallest radius of curvature smaller than a base resolution of the additive manufacturing technique. The at least one surface feature may include any of the surface features described herein, including, for example, surface features 46 and 48 of FIG. 3A, channels 56 of FIG. 3B, or features 72, 74, 76, 78, 80, 82, 84, or 86 of FIGS. 4A-4H.

The technique of FIG. 6 also includes forming a layer 26 (e.g., a plurality of roads 36) of material using an additive manufacturing technique (104). For example, in a fused filament deposition system such as additive manufacturing system 30, computing device 12 may control filament delivery device 34 to extrude softened or melted material 38 and deposit the softened or melted material 38 in roads 36 on structured surface 24. Softened or melted material 38 may be sufficiently soft or non-viscous to flow into intimate contact with the surface features on structured surface 24. Softened or melted material 38 may then cool and harden to substantially reproduce (e.g., reproduce or nearly reproduce) a complementary shape to structured surface 24, including the surface features.

The technique of FIG. 6 also includes forming, on the layer of material (e.g., formed of roads 36), at least one additional layer of material to form an additively manufactured component including the complementary shape (106). For example, computing device 12 may control movement and positioning of filament delivery device 34 relative to stage 18, and vice versa, to control the locations at which roads 36 are formed. Computing device 12 may control movement of energy delivery device 14, stage 18, or both, based on a computer aided manufacturing or computer aided design (CAM/CAD) file. For example, computing device 12 may control filament delivery device 34 to trace a pattern or shape to form a layer including a plurality of roads on the layer on structured surface 24. Computing device 12 may control filament delivery device 34 or stage 18 to move substrate 22 away from filament delivery device 34, then control filament delivery device 34 to trace a second pattern or shape to form a second layer including a plurality of roads on the previously deposited layer. Computing device 12 may control stage 18 and filament delivery device 34 in this manner to result in the plurality of layers, each layer including a traced shape or design. Together, the plurality of layers defines an additively manufactured component.

The technique of FIG. 6 further includes positioning a second substrate including a second structured surface adjacent to a build position, e.g., on stage 18 (108). The second substrate may be the same as or different than substrate 22. In some examples, the second substrate may include surface features that result in an additively manufactured component that, together with the first additively manufactured component formed using steps 82-86, define features in a final, third component formed by joining the first and second additively manufactured components. The at least one surface feature of the second substrate may have a smallest dimension or a smallest radius of curvature smaller than a base resolution of the additive manufacturing technique. The at least one surface feature in the second substrate may include any of the surface features described herein, including, for example, surface features 46 and 48 of FIG. 3A, channels 56 of FIG. 3B, or features 72, 74, 76, 78, 80, 82, 84, or 86 of FIGS. 4A-4H.

The technique of FIG. 6 also includes forming a layer 26 (e.g., a plurality of roads 36) of material adjacent to the second structured substrate using an additive manufacturing technique (110). This may be achieved like step (104) above. The technique of FIG. 5 also includes forming, on the layer of material (e.g., formed of roads 36), at least one additional layer of material to form a second additively manufactured component including the complementary shape (112). This may be achieved like step (106) above.

The technique of FIG. 6 then includes joining the surface of the first additively manufactured component that includes the first layer from step (104) to the surface of the second additively manufactured component that includes the second layer from step (112) (116). The first and second additively manufacture components may be joined an adhesive, solvent casting, or the like. The resulting third, final component may include internal features having a smallest dimension or a smallest radius of curvature smaller than a base resolution of the additive manufacturing system.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. An additive manufacturing system comprising:
a substrate comprising a structured surface comprising at least one surface feature having a smallest dimension or a smallest radius of curvature smaller than a base resolution of the additive manufacturing system;
means for additively forming layers of material using an additive manufacturing technique; and
a computing device configured to:
control the means for additively forming layers to form a layer of material on the structured surface of the substrate, wherein the layer of material substantially reproduces a complementary shape to the at least one surface feature;
control the means for additively forming layers to form, on the layer of material, at least one additional layer of material to form an additively manufactured component including the complementary shape.

2. The system of claim 1, wherein the means for additively forming layers of material comprises:
a fused deposition modeling device comprising a filament delivery device configured to output a heated filament comprising a polymer, wherein the heated filament cools to form the layer of material.

3. The system of claim 1, wherein the means for additively forming layers of material comprises:
a stereolithographic device comprising an energy source configured to output energy to selectively cure a photopolymer to form the layer of material.

4. The system of claim 1, wherein the at least one surface feature has a smallest dimension or a radius of curvature of that is less than about 500 micrometers.

5. The system of claim 1, wherein the at least one surface feature has a smallest dimension or a radius of curvature of that is less than about 250 micrometers.

6. The system of claim 1, wherein the at least one surface feature comprises a plurality of channels or ridges.

7. The method of claim 6, wherein a spacing between adjacent channels or ridges is less than 500 micrometers.

8. The system of claim 1, wherein the substrate is a first substrate, the layer of material is a first layer of material, the at least one surface feature is at least one first surface feature, and the additively manufactured component is a first additively manufactured component, wherein the computing device is further configured to:
control the means for additively forming layers of material to form, on a structured surface of second substrate, a second layer of material using an additive manufacturing technique, wherein the structured surface of the second substrate includes at least one second surface feature having a smallest dimension or a smallest radius of curvature smaller than a base resolution of the additive manufacturing technique, and wherein the second layer of material substantially reproduces a complementary shape that is complementary to the at second least one surface feature;
control the means for additively forming layers of material to form, on the second layer of material, at least one additional layer of material to form a second additively manufactured component including the complementary shape, wherein the first layer of material and the second layer of material are joined to form a third component including the first additively manufactured component, the second additively manufactured component, and a cavity or channel defined by the complementary shapes.

9. A method comprising:
forming, on a surface of a structured substrate, a layer of material using an additive manufacturing technique, wherein the structured surface of the substrate includes at least one surface feature having a smallest dimension or a smallest radius of curvature smaller than a base resolution of the additive manufacturing technique, and wherein the layer of material substantially reproduces a complementary shape to the at least one surface feature; and
forming, on the layer of material, at least one additional layer of material to form an additively manufactured component including the complementary shape.

10. The method of claim 9, wherein the additive manufacturing technique includes fused deposition modeling or stereolithography.

11. The method of claim 9, wherein the at least one surface feature has a smallest dimension or a radius of curvature of that is less than about 500 micrometers.

12. The method of claim 9 or wherein the at least one surface feature has a smallest dimension or a radius of curvature of that is less than about 300 micrometers.

13. The method of claim 9, wherein the at least one surface feature comprises a plurality of channels or ridges.

14. The method of claim 13, wherein a spacing between adjacent channels or ridges is less than 500 micrometers.

15. The method of claim 9, wherein the substrate is a first substrate, the layer of material is a first layer of material, the at least one surface feature is at least one first surface feature, and the additively manufactured component is a first additively manufactured component, the method further comprising:
forming, on a structured surface of second substrate, a second layer of material using an additive manufacturing technique, wherein the structured surface of the second substrate includes at least one second surface feature having a smallest dimension or a smallest radius of curvature smaller than a base resolution of the additive manufacturing technique, and wherein the second layer of material substantially reproduces a complementary shape that is complementary to the at least one second surface feature;
forming, on the second layer of material, at least one additional layer of material to form a second additively manufactured component including the complementary shape; and
joining the first layer of material and the second layer of material to form a third component including the first additively manufactured component, the second additively manufactured component, and a cavity or channel defined by the complementary shapes.

16. A computer-readable storage device comprising instructions that, when executed, configure one or more processors of a computing device to:
control means for additively forming layers of material using an additive manufacturing technique to form, on a structured surface of a substrate, a layer of material using an additive manufacturing technique, wherein the structured surface of the substrate includes at least one surface feature having a smallest dimension or a smallest radius of curvature smaller than a base resolution of the additive manufacturing technique, and wherein the layer of material substantially reproduces a complementary shape to the at least one surface feature; and
control the means for additively forming layers of material to form, on the layer of material, at least one additional layer of material to form an additively manufactured component including the complementary shape.

17. The computer-readable storage device of claim 16, wherein the means for additively forming layers of material comprises:
a fused deposition modeling device comprising a filament delivery device configured to output a heated filament comprising a polymer, wherein the heated filament cools to form the layer of material.

18. The computer-readable storage device of claim 16, wherein the means for additively forming layers of material comprises:
a stereolithographic device comprising an energy source configured to output energy to selectively cure a photopolymer to form the layer of material.

19. The computer-readable storage device of claim 16, wherein the at least one surface feature has a smallest dimension or a radius of curvature of that is less than about 500 micrometers.

20. The computer-readable storage device of claim 16, wherein the substrate is a first substrate, the layer of material is a first layer of material, the at least one feature is at least one first feature, and the additively manufactured component is a first additively manufactured component, wherein the computer-readable storage device further comprises instructions that, when executed, configure the one or more processors of the computing device to:
control the means for additively forming layers of material to form, on a surface of second substrate, a second layer of material using an additive manufacturing technique, wherein the surface of the second substrate includes at least one second feature having a smallest dimension or a smallest radius of curvature smaller than a base resolution of the additive manufacturing technique, and wherein the second layer of material substantially reproduces a complementary shape that is complementary to the at second least one feature;
control the means for additively forming layers of material to form, on the second layer of material, at least one additional layer of material to form a second additively manufactured component including the complementary shape, wherein the first layer of material and the second layer of material are joined to form a third component the additively manufactured component, the second additively manufactured component, and a cavity or channel defined by the at least one first feature and the at least one second feature.
